(19) United States
(12) Patent Application Publication
(10) Pub. No.: US 2009/0003552 A1
(43) Pub. Date: Jan. 1, 2009

(54) Personal message expiration

(75) Inventors: Stuart O. Goldman, Scottsdale, AZ (US); Richard E. Krock, Naperville, IL (US); Karl F. Rauscher, Emmaus, PA (US); James P. Runyon, Wheaton, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc.

(21) Appl. No.: 11/824,355

(22) Filed: Jun. 29, 2007

(51) Int. Cl. H04M 1/64

(52) U.S. Cl. 379/88.22

(57) ABSTRACT

A method for eliminating expired personal messages routed over a telecommunications network includes: receiving a message from a message originator for an intended recipient; at least temporarily storing the message; determining when the message expires based upon an expiration parameter included with the message; and, deleting the stored message automatically after the message expires.

### FIELD

The present inventive subject matter relates to the art of personal messaging. Particular application is found in connection with e-mail messaging, text or multimedia messaging and voicemail messaging, and the specification makes particular reference thereto. However, it is to be appreciated that aspects of the present inventive subject matter are also amenable to other messaging formats and like applications.

### BACKGROUND

Generally, a range of personal messaging alternatives are widely available for individuals to communicate with one another over various telecommunications networks. Personal messaging, for example, provides a beneficial form of indirect communication. That is to say, an individual or party sending a message can create and/or send the desired message without having to directly interact with the intended recipient. Thereafter, the message is generally stored or otherwise held, e.g., until such time as the recipient chooses to view, listen to or otherwise access the message at their convenience.

One form of widely used personal messaging is e-mail. For example, an individual may compose an e-mail message with a suitable e-mail client and send the e-mail message to a designated recipient over a telecommunications network, such as the Internet. As is well understood in the art, the e-mail message is generally relayed to the recipient via an e-mail server that holds or stores the e-mail message, e.g., until it is requested or otherwise accessed by the recipient via their e-mail client.

Text or multimedia messaging is also a widely used form of personal messaging, particularly in connection with wireless telecommunication networks. For example, SMS (Short Message Service), EMS (Enhanced Message Service), MMS (Multimedia Message Service) and the like are messaging services commonly employed by individuals to send text and/or multimedia messages to designated recipients. In practice, an individual typically composes or otherwise creates a desired text/multimedia message (e.g., using a suitable client or application on their mobile phone or other suitable end user telecommunications device) and sends the text/multimedia message to a designated recipient. As is well understood in the art, the text/multimedia message is generally relayed to the recipient via a suitable messaging service center (e.g., a SMSC (SMS Center), MMSC (MMS Center) or other store-and-forward switching center) that holds or stores the text/multimedia message and later forwards it on to the recipient. For example, the text/multimedia message is generally forwarded to the recipient's mobile phone or other suitable end user telecommunications device when the text/multimedia message is requested or otherwise retrieved by the recipient or alternately when the destination device becomes available to receive the text/multimedia message. Typically, once the text/multimedia message has been received by the destination device, the recipient optionally employs a suitable client or application on the destination device to view and/or listen to the text/multimedia message at their convenience.

Voicemail is yet another form of widely used personal messaging available for voice messages. Typically, when a called party is unavailable (e.g., away from their telephone or already engaged in another call) or when a calling party desires to leave a message rather than speak directly with the called party, the calling party is routed or otherwise directed to a voicemail system or messaging service where the calling party may leave a voicemail message for the intended recipient. Commonly, an automated attendant (AA) and/or IVR (Interactive Voice Response) feature associated with the voicemail system prompts, directs and/or otherwise aids the calling party to establish the voicemail message. In general, the voicemail system holds or stores the voicemail message until it is requested or otherwise accessed at the convenience of the intended recipient, e.g., via their telephone or other suitable end user telecommunications device.

While general beneficial, traditional personal messaging has certain drawbacks. More specifically, insomuch as the respective personal messages are generally accessed (e.g., viewed, heard or otherwise) at the will of the recipient, the message or its content may not actually reach or be known to the recipient for some time. Nevertheless, various messages may contain time sensitive information; that is to say, information that will be of little to no value or interest to the recipient after a particular period of time has elapsed. However, with traditional personal messaging services, such time sensitive messages are still delivered and/or otherwise remain available to the recipient even after the particular time period has lapsed. Accordingly, when retrieving and/or reviewing their messages after the particular time period has lapsed, the recipient can be undesirably burdened with having to view or listen to messages that are no longer meaningful or of interest to the recipient.

Accordingly, a new and improved system and/or method for managing and/or administering personal messages is provided that overcomes the above-referenced problems and others.

### SUMMARY

In accordance with one embodiment, a method is provided for eliminating expired personal messages routed over a telecommunications network. The method includes: receiving a message from a message originator for an intended recipient; at least temporarily storing the message; determining when the message expires based upon an expiration parameter included with the message; and, deleting the stored message automatically after the message expires.

In accordance with another embodiment, a system for eliminating expired personal messages routed over a telecommunications network includes: message service means for receiving a message from a message originator for an intended recipient; storage means for at least temporarily storing the message; decision means for deciding when the message expires based upon an expiration parameter included with the message; and, message elimination means for deleting the stored message automatically after the message expires.

Numerous advantages and benefits of the inventive subject matter disclosed herein will become apparent to those of ordinary skill in the art upon reading and understanding the present specification.

### BRIEF DESCRIPTION OF THE DRAWINGS

The inventive subject matter may take form in various components and arrangements of components, and in various steps and arrangements of steps. The drawings are only for purposes of illustrating preferred embodiments and are not to be construed as limiting. Further, it is to be appreciated that the drawings are not to scale.

FIG. 1 is a diagrammatic illustration of an exemplary generic personal messaging system suitable for practicing aspects of the present inventive subject matter.

FIG. 2 is flow chart illustrating an exemplary process and/or method for practicing aspects of the present inventive subject matter.

### DETAILED DESCRIPTION OF PREFERRED EMBODIMENTS

For clarity and simplicity, the present specification shall refer to structural and/or functional elements, relevant standards and/or protocols, and other components that are commonly known in the art without further detailed explanation as to their configuration or operation except to the extent they have been modified or altered in accordance with and/or to accommodate the preferred embodiment(s) presented herein.

Generally, the present specification discloses a method and/or system for administering and/or managing personal messages. More specifically, when creating a message (e.g., an e-mail message, text/multimedia message, voicemail message or the like), the message originator specifies an expiration date and/or time or a duration after which the originator desires the message to expire. An appropriate expiration parameter is accordingly pre-pended to, appended to or otherwise included with the message that is in turn sent or otherwise left for the indented recipient. Suitably, the message is held or stored at an appropriate location until it is requested or accessed by the recipient. However, provided the recipient has not yet requested or accessed the message (i.e., the message remains unopened or unaccessed), the message is automatically deleted, eliminated or otherwise cancelled after it has expired, e.g., as determined from the included expiration parameter.

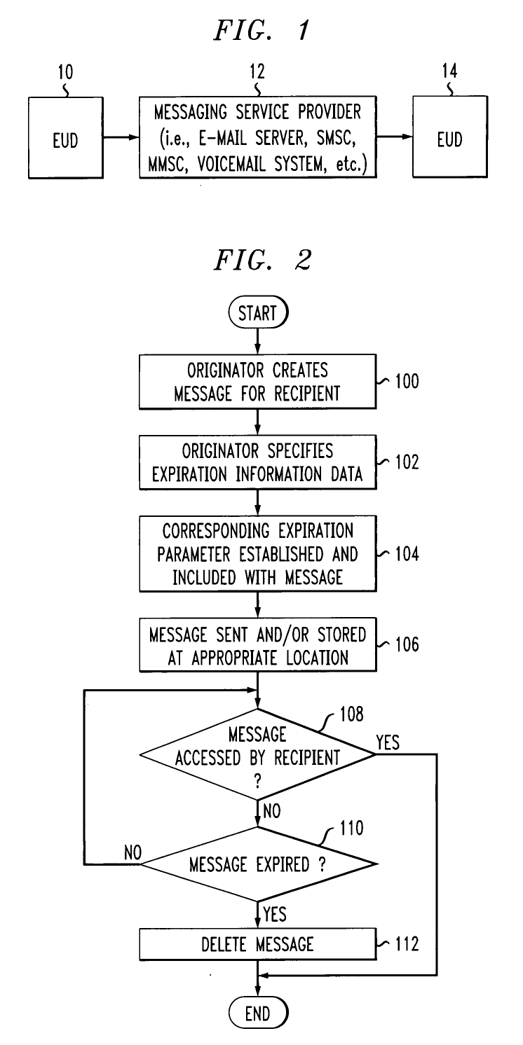

Reference is now made to the FIGURES, where FIG. 1 shows a first end user device (EUD) 10 that is operatively connected to and/or in communication with a message storage and/or relay component 12 (e.g., a messaging service provider) that is in turn operatively connected to and/or in communication with a second EUD 14. In practice, depending on the type of personal messaging that is applicable, the EUDs 10 and 14 and the message storage/relay component 12 may take one or more various forms. Additionally, the telecommunication networks over which the messages are routed and/or by which the respective elements communicate with one another may likewise vary depending upon the type of personal messaging involved.

For example, in a first exemplary embodiment applicable to e-mail messages (e.g., exchanged via the Internet), the EUDs 10 and 14 are optionally implemented as appropriate computers or the like on which suitable e-mail clients or other like applications are running or otherwise supported; and the message storage/relay component 12 is suitably implemented as an appropriate e-mail server or the like. Alternately, in a second exemplary embodiment applicable to text and/or multimedia messages (e.g., exchanged via a wireless telecommunications network), the EUDs 10 and 14 are optionally implemented as mobile phones or other like mobile stations or similar end user telecommunications devices on which suitable SMS, EMS or MMS clients or other like applications are running or otherwise supported; and the message storage/relay component 12 is suitably implemented as an appropriate SMSC, MMSC or other like store-and-forward switching center. In yet a third exemplary embodiment applicable to voicemail messages (e.g., exchanged via a public switched telephone network (PSTN)), the EUDs 10 and 14 are optionally implemented as telephones or other like end user telecommunications devices; and the message storage/relay component 12 is suitably implemented as an appropriate voicemail system (e.g., including an associated AA and/or IVR feature).

In any event, a message originator suitably employs the EUD 10 to create and send or otherwise leave a personal message for an intended recipient which generally at some later point in time selectively employs the EUD 14 to obtain and/or otherwise access the message. In accordance with the various exemplary embodiments, the message is suitably first received from the EUD 10 at the component 12 which at least temporarily holds or stores the message before forwarding or relaying it to the EUD 14.

More specifically, in accordance with the first exemplary embodiment, the message originator employs the EUD 10 (e.g., an e-mail client running on the originator's computer) to compose or otherwise create a desired e-mail message and send the e-mail message to an intended recipient. The e-mail message is in turn routed (e.g., over the Internet) to the component 12 (e.g., an e-mail server) where the e-mail message is held or stored for the intended recipient. Thereafter, presuming the e-mail message has not already been deleted due to expiration as described herein, the recipient selectively employs the EUD 14 (e.g., an e-mail client running on the recipient's computer) to retrieve or access the e-mail message from the component 12.

In accordance with the second exemplary embodiment, the message originator employs the EUD 10 (e.g., an SMS, EMS or MMS application on the originator's mobile station (MS)) to compose or otherwise create a desired text/multimedia message and send the text/multimedia message to an intended recipient. The text/multimedia message is in turn routed (e.g., over a wireless telecommunications network) to the component 12 (e.g., a SMSC, MMSC or other store-and-forward switching center) where the text/multimedia message is held or stored for the intended recipient. At some point thereafter, presuming the text/multimedia message has not already been deleted due to expiration as described herein, the component 12 forwards the text/multimedia message to the recipient's EUD 14 (e.g., an SMS, EMS or MMS application on the recipient's MS). In practice, the text/multimedia message is generally forwarded automatically when the destination EUD 14 becomes available to receive the text/multimedia message or alternately when the recipient uses the EUD 14 to retrieve or access the text/multimedia message from the component 12. In either case, once the text/multimedia message has been received by the destination EUD 14, the recipient selectively employs the EUD 14 to view and/or listen to the text/multimedia message at their convenience.

In accordance with the third exemplary embodiment, the message originator employs the EUD 10 (e.g., a telephone) to place a call which is ultimate routed (e.g., over the PSTN) or otherwise connected to the component 12 (e.g., a voicemail system). Aided by suitable prompts from the component 12 for example, the message originator creates and leaves or otherwise establishes a desired voicemail message which is held or stored by the component 12 for the intended recipient. Thereafter, presuming the voicemail message has not already been deleted due to expiration as described herein, the recipient selectively employs the EUD 14 (e.g., a telephone) to request or access the voicemail message from the component 12.

Suitably, in any event, when a personal message is created, the message originator optionally specifies an expiration date and/or time or a duration after which the originator desires the message to expire. This expiration date/time or duration is also nominally referred to herein as the expiration information or data. In practice, for example, in the first and second exemplary embodiments, the message composition client or application (i.e., the e-mail client or SMS, EMS, or MMS application on the EUD 10 as the case may be) is suitably provisioned to receive and/or accept the expiration information or data entered by the message originator via the EUD 10 or otherwise input. In the third exemplary embodiment, suitably, the voicemail system (i.e., component 12) is provisioned to receive and/or accept the expiration information or data entered by the message originator via the EUD 10 or otherwise input. Optionally, for example, an AA or IVR feature associated with the voicemail system prompts the message originator (i.e., the calling party) for the input expiration information.

In accordance with the expiration information or data specified by the message originator and/or otherwise supplied via the EUD 10, a corresponding expiration parameter is established and pre-pended to, appended to or otherwise included with the associated personal message. Optionally, the expiration parameter is embedded or otherwise included in the message's header, e.g., in a field designated therefor. More specifically, in the first and second exemplary embodiments, the message composition client/application is optionally provisioned to establish and embed or otherwise include the expiration parameter in the message when the message is created and/or sent. In the third exemplary embodiment, the voicemail system is optionally provisioned to establish and embed or otherwise include the expiration parameter in the message when the message is created and/or stored in the voicemail system.

Suitably, the component 12 (i.e., the e-mail server, SMSC, MMSC or other store-and-forward switching center, or the voicemail system as the case may be for the various embodiments) is provisioned to detect or otherwise monitor the expiration parameters of unopened or unaccessed messages held or stored by the component 12. Accordingly, to eliminate unopened or unaccessed messages that have expired (e.g., as determined in accordance with the detected or monitored expiration parameters) prior to being forwarded, relayed or otherwise delivered to the EUD 14, the component 12 deletes or cancels the corresponding unopened or unaccessed expired messages. In this manner, a recipient using the EUD 14 to retrieve or otherwise access their messages from the component 12 does not receive expired messages and is therefore not burdened with having to view or listen to them. Optionally, when a message is automatically deleted because it has expired, the system will treat notification of the EUD 14 the same as it would if the message were manually deleted by the recipient. That is to say, if the expired message being automatically deleted is the only message waiting for delivery, an otherwise illuminated message waiting indicator is suitably turned off, e.g., via an appropriate control signal being sent to the recipient's EUD 14.

In some cases and/or in particular embodiments, the component 12 is configured to automatically forward or relay the message to the EUD 14 for storage locally on the EUD 14 without the recipient actively requesting or otherwise retrieving the message from the component 12—that is, for example, provided the component 12 has not already deleted the message due to expiration. For example, an SMSC, MMSC or other like store-and-forward switching center generally forwards text/multimedia messages to the EUD 14 automatically when the EUD 14 is available to receive such messages. In this case, the forwarded message is commonly stored locally on the EUD 14 where it otherwise remains available for access by the recipient at their convenience. Accordingly, to eliminate locally stored but otherwise unopened or unaccessed messages that have expired, the EUD 14 is also suitably provisioned to detect or monitor the expiration parameters of unopened or unaccessed massages and delete the corresponding locally stored messages that have expired, e.g., as determined in accordance with their expiration parameters.

Of course, as can be appreciated, a recipient may at times still desire to retain access to otherwise expired messages. Accordingly, a mechanism is suitably provided by which the recipient may selectively activate or deactivate the expiration feature described therein. Notably, insomuch as the message deleting portion of the feature is generally executed by the component 12 which provides service to the recipient and/or the recipient's EUD 14, suitably, the recipient merely sets or otherwise indicates a desired activation status from time-to-time as desired, e.g., via the EUD 14.

With reference now to FIG. 2, the illustrated flow chart shows and exemplary process or method for administering and/or managing personal messages which includes an exemplary message expiration feature.

At step 100, a message originator creates a personal message for an intended recipient, and at step 102, the message originator optionally specifies expiration information or data for the message.

At step 104, an expiration parameter is set or otherwise established in accordance with the originator specified expiration information or data, and the expiration parameter is pre-pended to, appended to, embedded in or otherwise included with the message.

At step 106, the message is optionally sent to or left for the recipient and stored at a suitable location from which it can be selectively accessed by the recipient at their convenience.

At decision step 108, it is determined if the message has been access by the recipient. If the message has been accessed, then the process skips to the end bypassing steps 110 and 112. In this case, the message has been accessed prior to its expiration and accordingly it should not later be deleted in accordance with its otherwise prescribed expiration. Alternately, if the message is unopened or unaccessed, then the process continues to step 110.

At decision step 110, it is determined if the message has expired, e.g., based upon the included expiration parameter. If the message has not expired, then the process loops back to step 108, otherwise if the message has expired, the process continues to step 112 and the message is deleted or cancelled. In this manner, unopened or unaccessed messages that have expired are eliminated.

In some instance, particularly considering the prevalence of integrated communications networks, a message may have its format altered along the way from originator to recipient. For example, an e-mail message may be converted to a voicemail message, a voicemail message may be converted to a text/multimedia message, etc. depending on the modality used by the respective parties and/or supported on the particular EUDs 10 and 14. Nevertheless, suitably, the expiration parameter remains intact or otherwise with the message. Accordingly, the expiration feature described herein remains functional even if the message changes format at some point along its route.

It is to be appreciated that in connection with the particular exemplary embodiments presented herein certain structural and/or function features are described as being incorporated in defined elements and/or components. However, it is contemplated that these features, to the same or similar benefit, may also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is also to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

What is claimed is:

1. A method for eliminating expired personal messages routed over a telecommunications network, said method comprising:
(a) receiving a message from a message originator for an intended recipient;
(b) at least temporarily storing the message;
(c) determining when the message expires based upon an expiration parameter included with the message; and,
(d) deleting the stored message automatically after the message expires.

2. The method of claim 1, further comprising:
determining if the message has been accessed by the recipient; and
omitting step (d) if the message has been access by the recipient prior to its expiration.

3. The method of claim 1, further comprising:
accepting expiration information specified by the message originator; and,
establishing the expiration parameter in accordance with the specified expiration information.

4. The method of claim 3, wherein the expiration information includes at least one of a date, a time or a duration after which the message originates desires the message to expire.

5. The method of claim 1, wherein the message is one of an e-mail message, a text message, a multimedia message or a voicemail message.

6. A system for eliminating expired personal messages routed over a telecommunications network, said system comprising:
message service means for receiving a message from a message originator for an intended recipient;
storage means for at least temporarily storing the message;
decision means for deciding when the message expires based upon an expiration parameter included with the message; and,
message elimination means for deleting the stored message automatically after the message expires.

7. The system of claim 6, further comprising:
determination means for determining if the message has been accessed by the recipient;
wherein if the message has been access by the recipient prior to its expiration, then the message elimination means does not delete the stored message.

8. The system of claim 6, further comprising:
means for accepting expiration information specified by the message originator; and,
means establishing the expiration parameter in accordance with the specified expiration information.

9. The system of claim 8, wherein the expiration information includes at least one of a date, a time or a duration after which the message originates desires the message to expire.

10. The system of claim 6, wherein the message is one of an e-mail message, a text message, a multimedia message or a voicemail message.

11. The system of claim 6, wherein the message service means is one of an e-mail server, a SMSC, a MMSC, a store-and-forward switching center or a voicemail system.

12. The method of claim 6, wherein the storage means, decision means and elimination means are incorporated with the message service means.

13. The method of claim 6, wherein the storage means, decision means and elimination means are incorporated in an end user telecommunications device employed by the recipient to receive the message from the message service means.
